(19) United States
(12) Patent Application Publication
(10) Pub. No.: US 2014/0216595 A1
(43) Pub. Date: Aug. 7, 2014

(54) Double Stage Bottled Soda Dispenser

(71) Applicant: Ahmad M Raad, Andover, MA (US)

(72) Inventor: Ahmad M Raad, Andover, MA (US)

(21) Appl. No.: 13/758,216

(22) Filed: Feb. 4, 2013

(51) Int. Cl. B67D 3/00

(52) U.S. Cl. CPC B67D 3/0038
USPC 141/1; 222/1; 222/190; 141/311 R

(57) ABSTRACT

The present invention relates to a method and a device to dispense carbonated beverage from bottled soda while preventing the carbonation from escaping the soda bottle.

### RELATED APPLICATION

The present invention claims the benefit of provisional U.S. Patent No. 61/595,197 filed on Feb 6, 2012.

### BACKGROUND OF THE INVENTION

1. Field of the Invention

The field of the invention relates to soda dispensers in general and more particularly to dispensing methods and devices for bottled carbonated beverages.

2. Description of Related Art

Carbonated beverages are commonly sold in a variety of containers. While two liter soda bottles are popular among consumers, if all their content is not consumed right after removing the cap for the first time or shortly thereafter, the remaining soda loses much of the carbonation, turns flat and goes to waste.

Soda bottles are pressurized with carbon dioxide to higher than the ambient atmospheric pressure in the bottling companies. The dissolved carbon dioxide in the soda remains in a dynamic equilibrium with the carbon dioxide in the bottle's headspace.

When the bottle cap is removed for the very first time, the carbonation in the small headspace leaves the bottle right away. After pouring some soda and closing the cap, the soda releases carbon dioxide into the air-filled headspace until it reaches dynamic equilibrium again. This scenario repeats every time the cap is removed and as the soda level drops and the air pocket volume gets larger, the amount of lost carbonation progressively increases and the soda turns flat faster.

Carbon dioxide solubility decreases as the liquid temperature increases. In other words, keeping the soda bottles in a colder environment, such as in a refrigerator, lowers the rate of carbonation loss; therefore retaining the carbonation for a longer time even after it is poured into a glass. Leaving the bottle cap off for extended periods of time as well as not closing it tight enough are other major reasons for loss of carbonation.

The size, shape and weight of the larger soda bottles contribute to difficulties in lifting the bottle and pouring the content into a glass or cup, often with unexpected messy results especially if tried by younger children.

The present invention minimizes the carbonation loss of the bottled soda by eliminating the need for frequent cap removal and by trapping the carbonation inside the bottle. Furthermore, while keeping the beverage chilled, the dispenser provides a convenient dispensing experience from refrigerator shelf without having to remove it from the refrigerator and on countertops or tabletops without having to lift the bottle.

### SUMMARY OF THE INVENTION

A primary object of the invention is to prevent the carbonation from escaping the soda bottle, thus keeping the beverage carbonated for extended lengths of time while providing a convenient and practical method and device to dispense the soda smoothly into a glass or cup.

A second object of the invention is to eliminate the need for picking up the soda bottle at the time of dispensing and thus eliminating possible spillage due to the size, weight and the shape of the bottle.

A further object of the invention is to make the assembled soda bottle on the dispenser unit portable and to allow the consumer to suitably place it on a refrigerator shelf and while chilling the beverage, when desired, dispense the soda without the need for removing it from the refrigerator.

A further object of the invention is to provide capabilities of such device primarily for 2-liter and 1.5-liter bottled soda.

A further object of the invention is to make countertop or tabletop dispensing effortless by placing the dispenser on a detachable base and by making one-hand dispensing possible.

### BRIEF DESCRIPTION OF THE DRAWINGS

FIG. 1. Fully assembled dispenser including soda bottle, dispenser unit and base

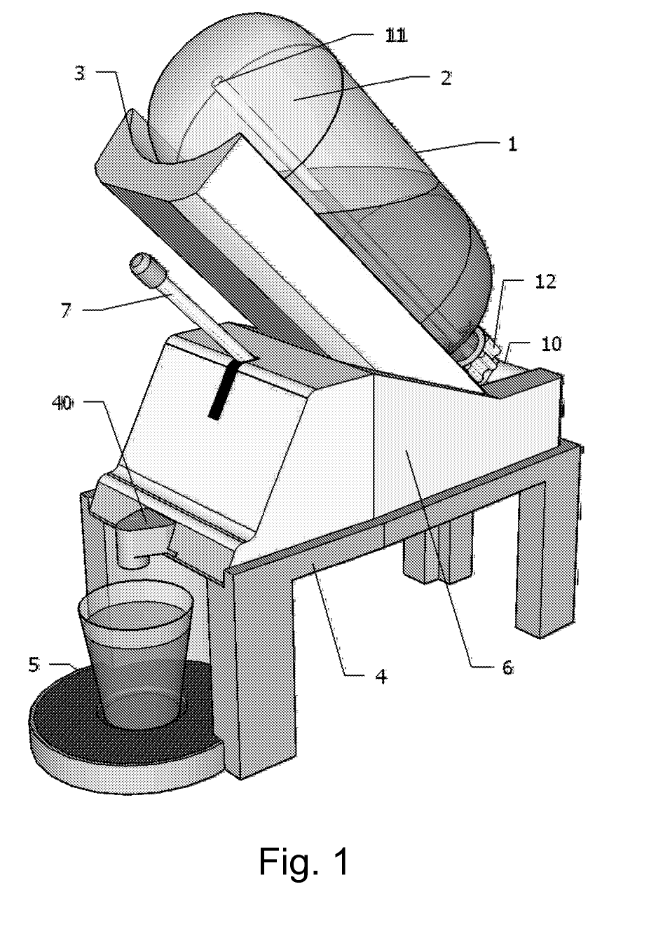

FIG. 2. Mounting dispenser unit on a full soda bottle

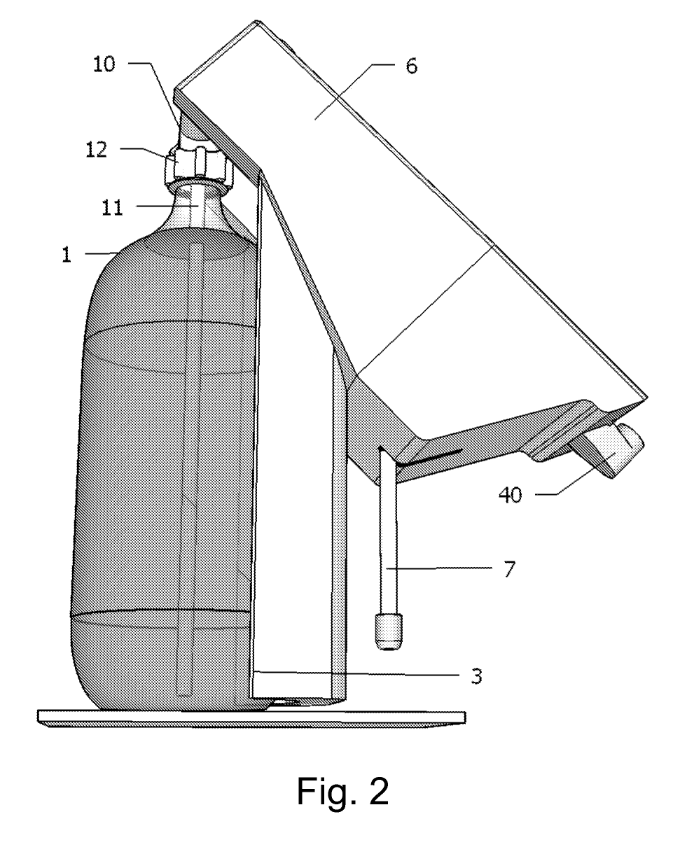

FIG. 3. Dispenser unit interior—view 1

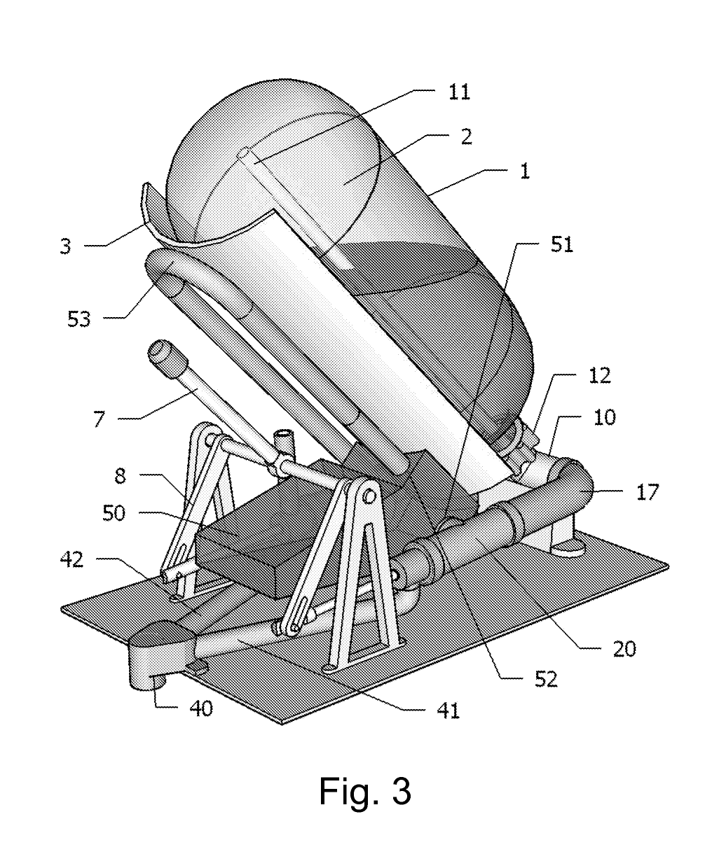

FIG. 4. Dispenser unit interior—view 2

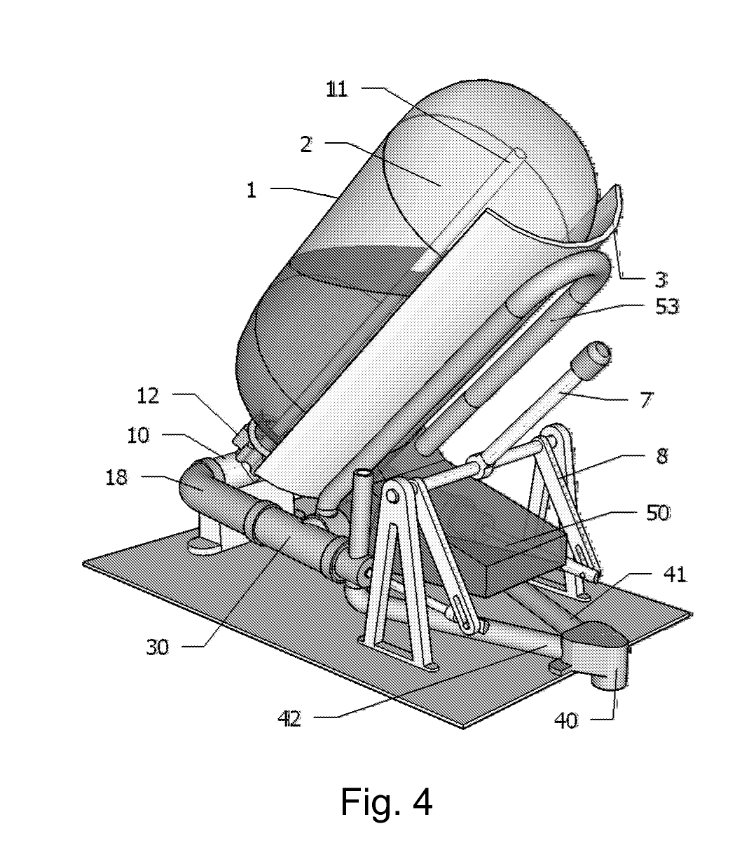

FIG. 5. Distribution cap details

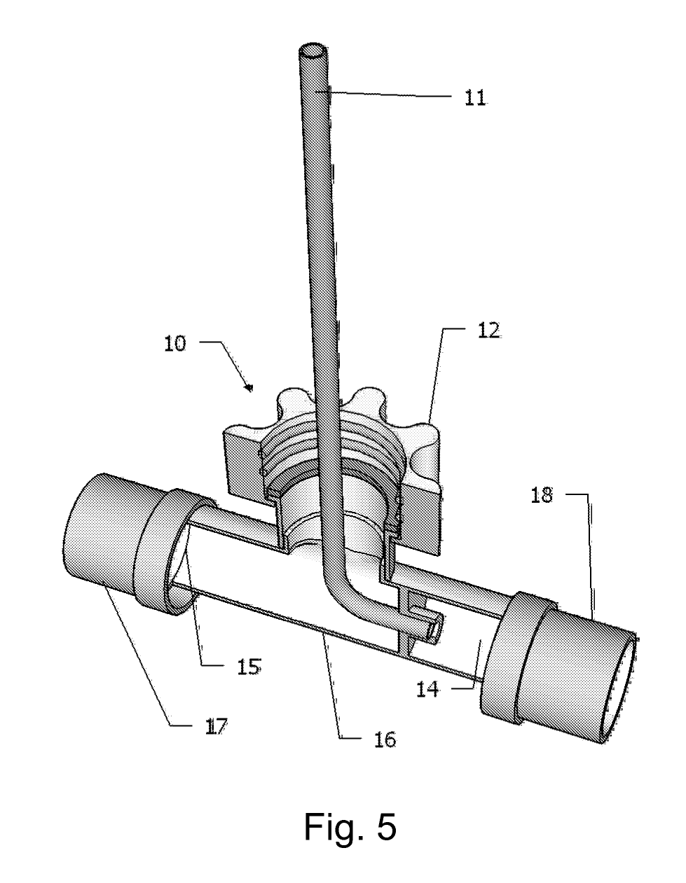

FIG. 6. Valve system details—Idle position

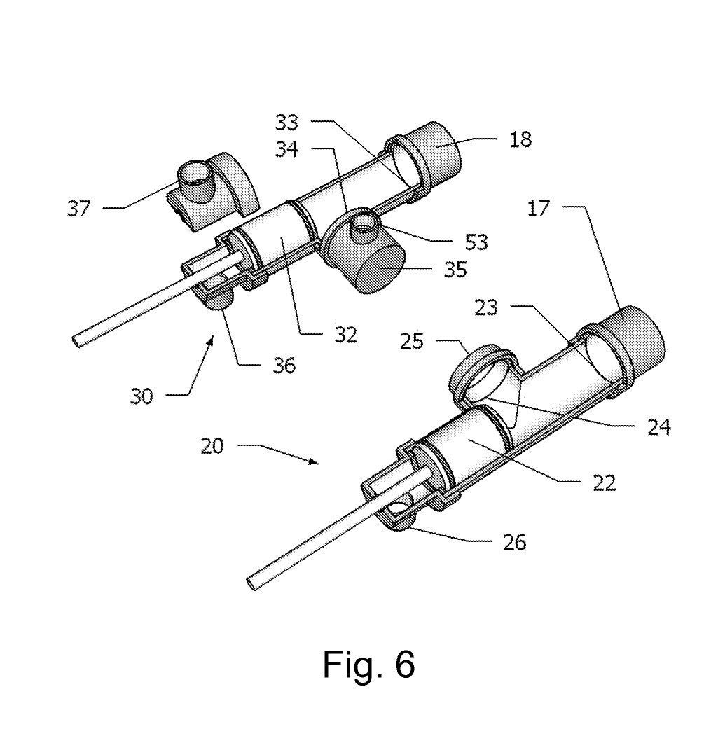

FIG. 7. Valve system details—Dispense position

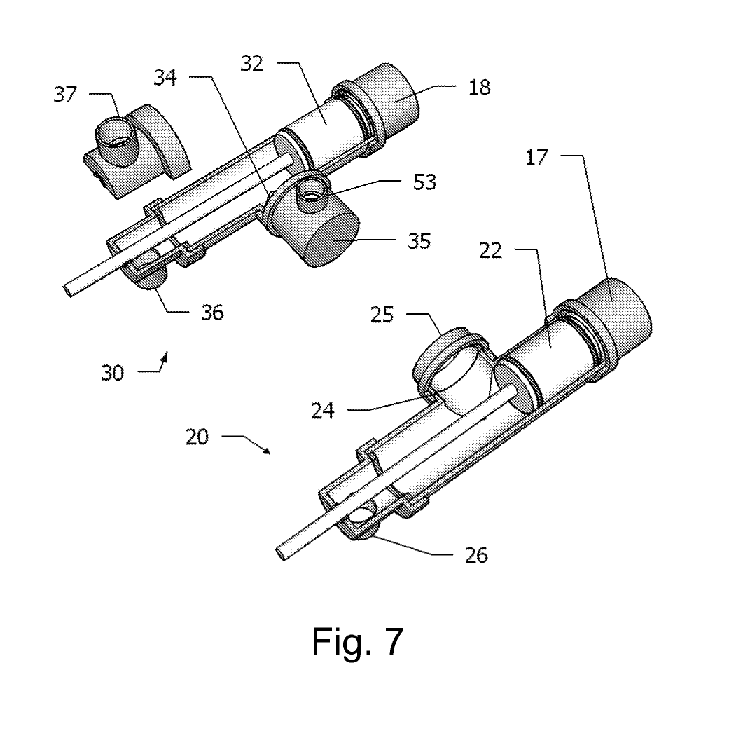

FIG. 8. 1.5-liter soda bottle installed on the dispenser unit

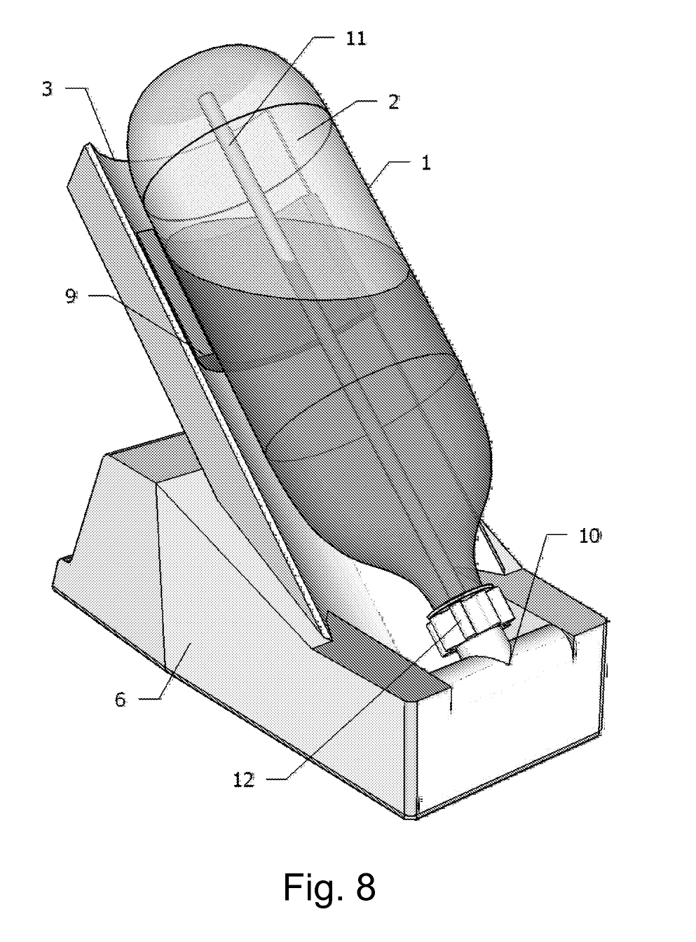

### DETAILED DESCRIPTION OF THE INVENTION

1. Method

The device, whose functionality is explained below, is designed based on a method with two major steps.

Consider a closed system consisting of a full soda bottle and a smaller empty container. The bottle and the container are connected but neither has connections to the outside atmosphere.

Step 1: Let the smaller container (reservoir) get filled with soda from the soda bottle while the air inside the reservoir moves to the soda bottle and replaces the displaced soda. No air from the outside enters this closed system.

Step 2: Disconnect the reservoir from the soda bottle while keeping the soda bottle isolated from the outside air. Let the soda dispense from the reservoir (into a glass or a cup) while the outside air enters the reservoir and replaces the displaced soda. Disconnect the empty reservoir from the outside air and reconnect it to the soda bottle and reestablish the closed system. Repeat step 1 and continue.

In this method, since the content of the bottle's air pocket is trapped and never exposed to open atmosphere, the soda remains maximally carbonated.

2. Device

The main components of the invention are distribution cap 10, valve system consisting of one soda valve 20 and one air valve 30, dispensing lever 7, reservoir 50, and nozzle 40.

The distribution cap 10 replaces the soda bottle's screw cap and consists of an air tube 11, which is inserted into the soda bottle 1 and a captive nut 12 that seals its T-shape cylindrical connector 16 to the bottle top. When the soda bottle 1 is inverted, the distribution cap air gate 14 provides access to the bottle's air pocket 2 via the air tube 11, while the distribution cap soda gate 15 outputs the liquid.

Both the soda valve 20 and the air valve 30 are specially designed piston valves. The soda valve 20 has three gates. The soda valve bottle gate 23 receives the soda from the distribution cap soda gate 15 via the soda distribution elbow 17. The soda valve output gate 26 delivers the soda to the nozzle 40 via the nozzle soda tube 41. The soda valve reservoir gate 24 connects the soda valve 20 to the reservoir 50 via the reservoir soda tube 25 and depending on the position of the soda valve piston 22, delivers the soda from the soda valve bottle gate 23 to the reservoir 50 or delivers the soda from the reservoir 50 to the soda valve output gate 26.

The air valve 30 has four gates. The air valve bottle gate 33 connects the air valve 30 to the distribution cap air gate 14 via the air distribution elbow 18. The air valve upper output gate 37 and lower output gate 36 bring in the outside air into the air valve 30. In addition, the air valve lower output gate 36 is connected to the nozzle 40 via the nozzle air tube 42 and delivers incidental trapped liquid or moisture from the air valve 20 to the nozzle 40. Incidental liquid is trapped in the air valve liquid trapping barrel 35 located at the air valve reservoir gate 34. The air valve reservoir gate 34 connects the air valve 30 to the top of the reservoir 50 via the liquid trapping barrel 35 and reservoir air tube 53. Depending on the position of the air valve piston 32, the air valve reservoir gate 34 connects the reservoir 50 to the bottle's air pocket 2 or delivers the outside air to the reservoir 50.

The reservoir 50 is located beneath the soda bottle holding bed 3. It has two gates. The reservoir air gate 52 located at the highest possible elevation and the reservoir soda gate 51 located at the lowest possible elevation of the reservoir 50. The bottom of the reservoir 50 is tilted towards the reservoir soda gate 51 to make the complete drainage possible. In general, the locations, elevations and slopes of the components ensure the proper displacement of the soda within the device with the soda bottle 1 at the highest elevation and the nozzle 40 at the lowest.

The spring loaded dispensing lever 7 has two distinct positions, idle and dispense. It is connected to the soda valve piston 22 and the air valve piston 32 via moving mechanical arms 8. The dispensing lever 7 is normally in idle position, and so are the two pistons 22 and 32. When the dispensing lever 7 moves down to dispense position, the two pistons 22 and 32 move up inside the respective valves 20 and 30 and assume dispense positions as well. When the dispensing lever 7 is released, it returns to the idle position again and so do the two pistons 22 and 32.

How the Components Work Together

First the screw cap is removed from the soda bottle 1. The dispenser unit 6 is then turned almost upside down and the distribution cap 10 aligns with the bottle's opening while the holding bed 3 touches the side of the soda bottle 1, engulfing it. The captive nut 12 is then turned clockwise and seals the distribution cap 10 on the soda bottle 1. The dispenser unit 6 along with the installed soda bottle 1 is then turned back to its normal position and placed on the base 4 or on refrigerator shelf. The base 4 keeps the dispenser unit 6 elevated so a glass or cup fits on its drip tray 5 under the nozzle 40.

Since the dispensing lever 7 and consequently the soda valve piston 22 and the air valve piston 32 are all in idle position, the soda enters and fills the reservoir 50 via the soda valve 20 and in exchange, the air within the reservoir 50 is pushed out, moving up to the bottle's air pocket 2 via the reservoir air tube 53, the air valve 30 and the distribution cap air tube 11. When the reservoir 50 gets full and the level of the soda in the soda bottle 1 is still higher than the reservoir air gate 52, soda enters into the reservoir air tube 53 via the reservoir air gate 52 and moves up until reaching the same level as the soda in the soda bottle 1. In other words, the displacement of soda and air stops when the soda inside the bottle 1 and in the reservoir air tube 53 reach the same level. The U-shape reservoir air tube 53 is designed to a height such that it prevents soda from overflowing into the air valve 30.

When the dispensing lever 7 is pushed down to dispense position, the soda valve piston 22 and the air valve piston 23 move up to dispense position also. The soda moves out from the reservoir 50 towards the nozzle 40 via the soda valve 20 and the nozzle soda tube 41. At the same time, the outside air enters the reservoir 50 via the air valve 30 and the reservoir air tube 53 and replaces the soda.

When the dispensing lever 7 is released, it returns to the idle position and so do the soda valve piston 22 and the air valve piston 23. The soda from the soda bottle 1 fills the reservoir 50 again and the air at the top of the reservoir 50 is pushed up to the bottle's air pocket 2 again. The dispenser unit 6 is now ready for the next dispense action.

The holding bed 3 is primarily designed to host 2-liter soda bottles. However, by placing and securing an adjustment piece 9 on the inclined holding bed 3, 1.5-liter soda bottles could also be used, which are almost as tall as 2-liter bottles but have a smaller diameter.

What is claimed is:

1. A method and a device for dispensing carbonated beverage from a 2-liter soda bottle while preventing the carbonation from escaping the bottle into open air.

2. The device of claim 1, wherein a distribution cap replaces the soda bottle's screw cap and connects the content of the bottle, carbonated beverage and the bottle's headspace, to a valve system.

3. The device of claim 1, wherein a reservoir is located underneath the soda bottle and gets filled with the liquid from the soda bottle due to the higher elevation of the bottle, while in exchange, the existing air within the reservoir gets transferred up to the bottle.

4. The devise of claim 1, wherein a valve system manages the exchange of the liquid and air between the bottle and the reservoir, manages the isolation of the bottle's contents from the outside air, thus preventing the escape of the carbonation, and manages the transfer of the staged liquid from the reservoir to the nozzle.

5. The valve system of claim 4, wherein a single spring loaded lever (agitator) activates the valve system for each dispensing action and returns to normal position upon completion of dispensing.

6. The device of claim 1, wherein a nozzle receives the liquid from the reservoir via the valve system and delivers it into a glass or cup.

7. The device of claim 1, wherein an inclined holding bed secures a 2-liter soda bottle in place in a predefined angle to limit the height and to ensure the dispenser unit (along with the largest and/or tallest available 2-liter soda bottle installed) fit on most refrigerator shelves.

8. The holding bed of claim 7, wherein an adjustment mechanism optionally enables it to securely host 1.5-liter soda bottles instead of 2-liter bottles.

9. The device of claim 1, wherein a detachable base could optionally be placed under the dispensing unit for further elevation and to allow a normal size glass or cup to fit under the nozzle when the device is being used outside of the refrigerator.
